(19) United States
(12) Patent Application Publication
(10) Pub. No.: US 2024/0399945 A1
(43) Pub. Date: Dec. 5, 2024

(54) LIGHTWEIGHT SEAT SUPPORT ELEMENT

(71) Applicant: Faurecia Sièges d'Automobile, Nanterre (FR)

(72) Inventors: Sylvain ROCHE, Varennes Changy (FR); Frédéric MAZZAMURRO, SAINT-JEAN-DE-BRAYE (FR); Farouk BOUZID, BRETIGNY SUR ORGE (FR)

(21) Appl. No.: 18/680,300

(22) Filed: May 31, 2024

(30) Foreign Application Priority Data
May 31, 2023 (FR) FR 2305419

(51) Int. Cl. B60N 2/90; B60N 2/68

(52) U.S. Cl. CPC B60N 2/938; B60N 2/68; B60N 2002/952

(57) ABSTRACT

A vehicle seat support element having a body made of plastic material, a metal reinforcement attached to the body, and four interface elements for interfacing of the seat support element with its environment. Three of the interface elements are secured to the metal reinforcement, the fourth interface element only being secured to the body.

### TECHNICAL FIELD

The present invention relates to a vehicle seat support element, of the type comprising a body made of plastic material, a metal reinforcement attached to the body and four interface elements for interfacing of the seat support element with its environment.

### BACKGROUND

The invention applies for example to a vehicle seat backrest support element, in particular for a motor vehicle rear seat. Such a support element is generally movable between a raised position and a folded position relative to its environment and, in this respect, comprises articulation elements and locking elements for locking the position of the seat in the passenger compartment. These articulation and locking elements thus form interface elements for interfacing of the support element with its environment, formed by the passenger compartment of the vehicle and/or by one or more adjacent support elements.

It is known to attach these interface elements to a metal reinforcement extending into the support element in order to ensure robust attachment of the interface elements in the support element. The interface elements generally extending to the four corners of the support element, the reinforcement takes the form of a frame formed by cross members and uprights running along the periphery of the support element. Thus, the reinforcement has significant dimensions and makes the seat support element much heavier, in addition to increasing the production cost thereof, due to the amount of metal necessary to produce the reinforcement.

### SUMMARY

One of the aims of the invention is to overcome these disadvantages by proposing a support element comprising robust interface elements attached to the rest of the support element while lightening the support element.

To this end, the invention relates to a support element of the aforementioned type, wherein three of the interface elements are rigidly connected to the metal reinforcement, the fourth interface element only being secured to the body.

The arrangement of the support element of the seat allows reduced dimensions of the reinforcement, the latter extending only between three interface elements instead of four. Thus, the reinforcement is lightened, which lightens the support element as a whole and makes it less expensive to produce, the quantity of metal used being reduced. Additionally, such a reduction in the amount of metal makes it possible to reduce the carbon footprint related to producing the seat support element. The robust attachment of three interface elements to the reinforcement allows the support element to have satisfactory behavior, in particular in the event of impacts. The fourth interface element can also be attached robustly to the body, in particular by overmolding the interface element by the body. By choosing an interface element that is less biased in the event of an impact to be the one that is not connected to the reinforcement, the support element retains the desired robustness properties.

The support element may further comprise one or more of the following features, considered alone or in any technically feasible combination:
the body extends between a lower edge and an upper edge in an elevation direction and between two side edges in a transverse direction, substantially perpendicular to the elevation direction, the junction between the side edges and the lower edge forming the lower corners of the body and the junction between the side edges and the upper edge forming the upper corners of the body, the interface elements extending in the vicinity of the lower and upper corners of the body;
the reinforcement comprises a first branch extending substantially in the elevation direction along one of the side edges of the body and a second branch extending substantially in the transverse direction along the upper edge or the lower edge of the body, the first branch being attached at one of its ends to the second branch;
two interface elements extend at the opposite transverse ends of the second branch, a third interface element being attached to the free end of the first branch, opposite the end of the first branch attached to the second branch;
the reinforcement comprises a third branch extending between the first branch and the second branch in a direction inclined relative to the elevation direction and to the transverse direction;
the reinforcement and the fourth interface element are overmolded by the body;
the interface elements extending at the lower corners of the body are articulation elements of the support element to its environment, the support element being rotatable about an axis of rotation passing through said articulation elements;
the interface elements extending in the vicinity of the upper corners of the body are locking elements for locking the support element to its environment;
the body comprises reinforcing ribs integral with the rest of the body;
the support element forms part of a vehicle seat backrest.

According to another aspect, the invention relates to a vehicle seat support element, comprising a body made of plastic material, at least one interface element of the seat support element with its environment, said interface element being made of a metallic material, a first part of the interface element being inserted into the plastic material of the body, in particular by means of a branch, formed for example by a tube, the body defining a window devoid of plastic material, wherein a second part of the interface element extends.

### BRIEF DESCRIPTION OF THE DRAWINGS

Other aspects and advantages of the invention will appear on reading the following description, given by way of example and made with reference to the appended drawings, wherein:

FIG. 1 is a schematic front depiction of a support element according to an embodiment of the invention, and

FIG. 2 is a schematic front depiction of the reinforcement and the interface elements of the support element of FIG. 1.

### DETAILED DESCRIPTION

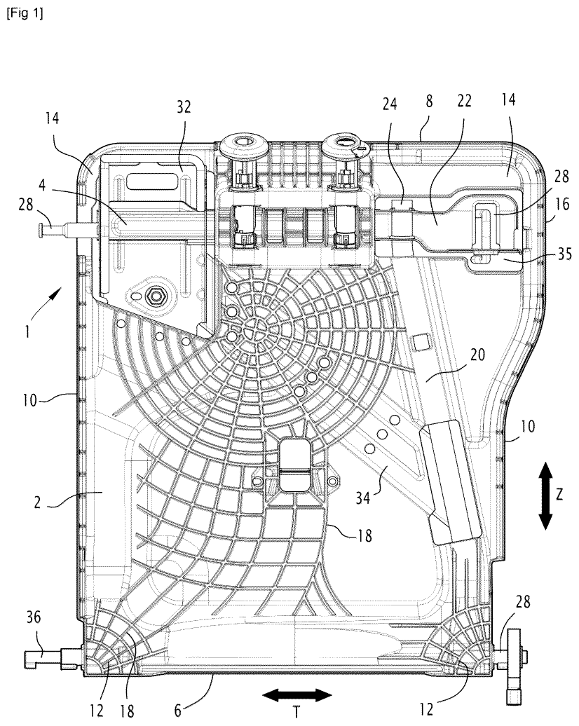

Referring to FIG. 1, a support element 1 comprising a body 2 made from plastic and a metal reinforcement 4 attached to the body 2 is disclosed. Such a support element 1 for example forms a part of a backrest for a seat of a vehicle, for example a motor vehicle, and the body 2 has, for this purpose, the general shape of such a backrest. The support element 1, shown in FIG. 1, is intended to be covered at least in part by padding (not shown), for example made of foam, which in turn is coated at least in part by a cap (not shown) to form the seat backrest. The padding and the cap are in no way unusual in the context of a vehicle backrest and will not be disclosed in more detail herein. The backrest thus formed for example forms the backrest of a rear seat of the vehicle.

The body 2 is made of plastic material, for example by injection molding. More particularly, the attachment between the body 2 and the reinforcement 4 is for example obtained by overmolding the body 2 onto the reinforcement 4 during the production of the body 2.

The body 2 is delimited by a lower edge 6 and an upper edge 8 in an elevation direction Z and by two side edges 10 in a transverse direction T. The elevation direction Z corresponds for example to the height of the vehicle when the support element 1 is in a raised position, which will be disclosed later, and the transverse direction T is substantially perpendicular to the elevation direction Z and corresponds for example to the width of the vehicle.

The junction zones between the side edges 10 and the lower edge 6 form the lower corners 12 of the body 2 and the junction zones between the side edges 10 and the upper edge 8 form the upper corners 14 of the body 2. The body 2 thus has a generally rectangular shape, although this shape can deviate from that of a rectangle, the upper corners 14 for example being rounded and one of the side edges 10 for example having a widening 16 in the vicinity of the upper corner 14 as shown in FIG. 1. It is understood, however, that the shape shown in FIG. 1 is only an example of a draft and that other shapes can be envisaged, in particular based on the location of the support element 1 in the passenger compartment of the vehicle.

Since the body 2 is made of plastic material, for example by injection molding, it is easy to integrate functional elements into or onto the body 2. Thus, the body 2 comprises, for example, reinforcing ribs 18 extending between the side edges 10 and/or the lower edge 6 and the upper edge 8. The shape and dimensions of reinforcing ribs 18 depend on the desired mechanical characteristics for the support element 1. The reinforcing ribs 18 are for example more particularly concentrated in zones requiring high mechanical strength in order to reinforce these zones. Reinforcing ribs 18 are for example provided in the lower corners 12 of the body 2, where articulation elements are provided, as will be disclosed later. The reinforcing ribs 18 are integral with the rest of the body 2. The shape and number and arrangement of the reinforcing ribs 18 shown in FIG. 1 are only given by way of example, and it is understood that these can vary from one support element 1 to another. The body 2 may comprise other functional elements made as a single part with the rest of the body 2, such as support elements for receiving elements added to the support element 1, screw shanks, etc. Reinforcing elements or other functional elements can also be overmolded by the body 2, in addition to the reinforcement 4. The body 2 may comprise one or more through openings, in particular for the passage or attachment of elements added to the support element 1.

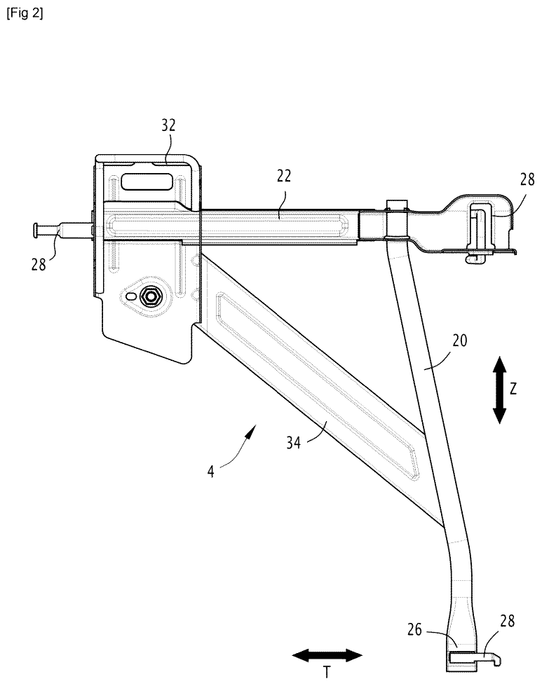

The reinforcement 4 extends in a part of the body 2 and is, at least partially, encapsulated by the material of the body 2. The reinforcement 4 in particular comprises a first branch 20 extending substantially in the elevation direction Z along one of the side edges 10 of the body 2 and a second branch 22 extending substantially in the transverse direction T along the upper edge 8 or the lower edge 6 of the body 2. Preferably and as shown in FIGS. 1 and 2, the second branch 22 extends along the upper edge 8 of the body 2.

The first branch 20 extends from the lower corner 12, corresponding to the side edge 10 along which the first branch 20 extends, to the second branch 22. According to the embodiment shown in the figures, the first branch 20 does not completely follow the side edge 10 and moves away therefrom by approaching the second branch 22, in particular at the widening 16 of the side edge 10. For a support element 1 forming a seat backrest extending between a wall of the passenger compartment of the vehicle and an adjacent seat, the side edge 10 along which the first branch 20 extends is more particularly the side edge 10 adjacent to the wall of the passenger compartment. The first branch 20 is for example substantially tubular. One of the ends of the first branch 20, namely the upper end 24 when the second branch 22 extends along the upper edge 8 of the body 2, is attached to the second branch 22, for example by welding. At the opposite end, namely the lower end 26, an interface element 28 is attached to the first branch 10, as will be disclosed in more detail later. The lower end 26 of the first branch 20 extends into the lower corner 12 of the body 2.

In the case where the second branch 22 extends along the upper edge 8 of the body 2, the second branch 22 extends from one upper corner 14 to the other of the body 2 in the transverse direction T, in the vicinity of the upper edge 8 but while being slightly separated therefrom. In other words, the second branch 22 extends in the elevation direction Z between the lower edge 6 and the upper edge 8 in the vicinity of the upper edge 8. The transverse ends 30 of the second branch 22 extend in the vicinity of the upper corners 14 of the body 2 and each bear an interface element 28, as will be disclosed in more detail later. The second branch 22 serves as upper cross member of the support element 1 and is shaped for this purpose, in particular to allow the transmission of energy from one end to the other of the cross member in the event of an impact. The second branch 22 can further be shaped to receive support rods of a headrest.

According to an embodiment shown in FIGS. 1 and 2, the second branch 22 further carries a support plate 32 extending mainly in the elevation direction in the vicinity of the transverse end 30 of the second branch 22 opposite the attachment zone of the first branch 20. This support plate 32 for example forms a seat belt support of the seat and/or of an adjacent seat.

According to one embodiment, also shown in FIGS. 1 and 2, the reinforcement 4 further comprises a third branch 34 extending between the first branch 20 and the second branch 22 and being inclined relative to the elevation direction Z and the transverse direction T. One of the ends of the third branch 34 is attached, for example by welding, to the first branch 20, in the vicinity of the lower end 26 of the first branch 20, and the other end is connected to the second branch 22 in the vicinity of the transverse end of the second branch 22 opposite the attachment zone of the first branch 20. When the reinforcement 4 comprises a support plate 32, as disclosed above, the third branch 34 is for example connected to the second branch 22 by being attached to the support plate 32, for example by welding, as is more particularly visible in FIG. 2.

Thus, the third branch 34 extends “diagonally” in the body 2 between the first branch 20 and the second branch 22, passing through a central part of the body 2, so that the third branch 34 reinforces the body 2 and promotes the transmission of energy between the second branch 22 and the first branch 20 in the event of impact on the support element 1.

The arrangement of the reinforcement 4 disclosed above is such that the reinforcement 4 does not extend in the lower corner 12 and in the vicinity of the lower corner 12 of the body 2 opposite the lower corner 12 wherein the first branch 20 extends. The arrangement is such that the reinforcement 4 does not extend throughout the part of the body going from the third branch 34 to this lower corner 12, which represents a large surface area of the body 2. The reinforcement 4 also does not extend along the lower edge 6 of the body 2, when the second branch 22 extends along the upper edge 8. Thus, relative to a conventional reinforcement that has a frame shape extending over the entire periphery of the body 2, the reinforcement 4 of the support element 1 only comprises a single side upright and only one of the lower and upper cross members. In other words, relative to a conventional reinforcement 4, the reinforcement 4 is lighter and less expensive because it does not require as much metal as a conventional reinforcement.

As indicated above, three interface elements 28 for interfacing the support element with its environment are secured to the reinforcement 4 disclosed above. “Interface element for interfacing the support element with its environment” means that the interface elements interact with the environment of the support element 1 to secure the interface element to this environment. The environment is more particularly formed by the passenger compartment of the vehicle and/or by one or more seats adjacent to the support element 1.

More particularly, a first of the interface elements 28 is attached to the lower end 26 of the first branch 20 and projects outside the body 2 in the transverse direction T at the corresponding lower corner 12, as is more particularly visible in FIG. 1. This first interface element 28 forms a hinge pin of the support element 1 to the passenger compartment of the vehicle, making it possible to make the support element 1 rotatable, as will be disclosed in more detail later. This interface element 28 is for example welded to the lower end of the first branch 20 and is overmolded by the body 2 with the reinforcement 4.

A second interface element 28 is integrated into the second branch 22 and forms one of the ends of the second branch 22 in the vicinity of the attachment zone of the upper end 24 of the first branch 20. “Integrated” means that the second interface element 28 is, according to the embodiment shown in the figures, integral with the second branch 22. Alternatively, the second interface element 28 is added to the second branch 22 and is attached thereto. The second interface element 28 is for example integrated into the body 2 between the attachment zone of the first branch 20 and the widening 16 of the side edge 10 of the body 2, as shown in FIG. 1. This second interface element 28 forms a lock support. Such a lock support is for example formed by an orifice receiving a complementary locking element provided in the passenger compartment. It is understood, however, that the second interface element 28 may have another shape.

According to the embodiment shown in FIG. 1, this interface element 28 extends into a window 35 forming an opening extending around the interface element 28. In other words, a part of the second branch 22 bearing the second interface element 28 does not extend into the body 2, but into an opening formed in this body.

Thus, the invention also relates to a vehicle seat support element 1, comprising a body 2 made of plastic material, at least one interface element 28 of the seat support element with its environment, said interface element being made of a metallic material, a first part of the interface element 28 being inserted into the plastic material of the body 2, in particular by means of a branch 24, formed for example by a tube, the body 2 defining a window 35 devoid of plastic material, wherein a second part of the interface element 28 extends.

Opposite the second interface element 28, a third interface element 28 is secured to the transverse end of the second branch 22 and projects outside the body 2 in the transverse direction T in the vicinity of the corresponding upper corner 14 of the body 2, as shown in FIG. 1. The third interface element 28 forms another element for locking a position of the support element 1 to a support element of an adjacent seat. The third interface element for example has the shape of a pin projecting from the body 2 in the transverse direction. It is understood, however, that the third interface element 28 may have another shape.

In addition to the three interface elements 28 secured to the reinforcement 4, the support element 1 comprises a fourth interface element 36 secured only to the body 2. “Secured only to the body 2” means that the fourth interface element 36 is not secured to the reinforcement 4. The fourth interface element 36 is for example overmolded by the body 2 and extends in the lower corner 12 of the body 2 opposite the lower corner 12 wherein the lower end 26 of the first branch 20 extends. The fourth interface element 36 further projects from the body 2 in the transverse direction T, as shown in FIG. 1. The fourth interface element 36 thus comprises a portion overmolded by the body 2 and a portion extending outside the body 2 in the transverse direction T. The fourth interface element 36 forms an articulation element for articulating the support element 1 to an adjacent seat. More particularly, the fourth interface element 36 forms, with the first interface element 28, an axis of rotation of the support element 1 extending in the transverse direction T, so that the support element 1 is movable between a raised position, wherein a passenger can press against the support element 1, and a folded position, wherein the support element 1 is for example folded against the seat bottom in order to free a storage space in the passenger compartment. The locking element formed by the second interface element 28 makes it possible for example to lock the support element 1 in the raised position, and the third interface element 28 makes it possible for example to secure two adjacent backrests so that they move together between the raised and folded-down positions.

The fourth interface element 36 secured only to the body 2 is for example chosen to be the one that requires the least mechanical strength in the event of impact on the support element 1 so that the fact that it is not secured to the reinforcement 4 does not prevent the support element 1 from having satisfactory behavior in the event of impact.

It is understood that the arrangement of the reinforcement 4 disclosed above is only given by way of example. Thus, the second branch could extend along the lower edge 6 so as to be secured to the first interface element 28 and the fourth interface element 36. In this case, it is the third interface element 28 that is secured only to the body 2 and not to the reinforcement 4.

The support element 1 disclosed above is lightened relative to a support element 1 comprising a conventional reinforcement. The support element 1 is thus less expensive to produce while maintaining satisfactory mechanical properties.

1. A vehicle seat support element, comprising a body made of plastic material, a metal reinforcement attached to the body, and four interface elements for interfacing of the seat support element with its environment, wherein three of the interface elements are secured to the metal reinforcement, the fourth interface element only being secured to the body.

2. The support element according to claim 1, wherein the body extends between a lower edge and an upper edge in an elevation direction and between two side edges in a transverse direction, substantially perpendicular to the elevation direction, the junction between the side edges and the lower edge forming the lower corners of the body and the junction between the side edges and the upper edge forming the upper corners of the body, the interface elements extending in the vicinity of the lower and upper corners of the body.

3. The support element according to claim 2, wherein the reinforcement comprises a first branch extending substantially in the elevation direction along one of the side edges of the body and a second branch extending substantially in the transverse direction along the upper edge or the lower edge of the body, the first branch being attached at one of its ends to the second branch.

4. The support element according to claim 3, wherein the two interface elements extend at the opposite transverse ends of the second branch, a third interface element being attached to the free end of the first branch, opposite the end of the first branch attached to the second branch.

5. The support element according to claim 3, wherein the reinforcement comprises a third branch extending between the first branch and the second branch in a direction inclined relative to the elevation direction and to the transverse direction.

6. The support element according to claim 1, wherein the reinforcement and the fourth interface element are overmolded by the body.

7. The support element according to claim 2, wherein the interface elements extending at the lower corners of the body are articulation elements of the support element to its environment, the support element being rotatable about an axis of rotation passing through said articulation elements.

8. The support element according to claim 2, wherein the interface elements extending in the vicinity of the upper corners of the body are locking elements for locking the support element to its environment.

9. The support element according to claim 1, wherein the body comprises reinforcing ribs integral with the rest of the body.

10. The support element according to claim 1, forming a part of a vehicle seat backrest.
